(19) United States
(12) Patent Application Publication
(10) Pub. No.: US 2025/0149695 A1
(43) Pub. Date: May 8, 2025

(54) BATTERY

(71) Applicant: TOYOTA JIDOSHA KABUSHIKI KAISHA, Aichi-ken (JP)

(72) Inventor: Shinya ISHIKAWA, Anjo-shi (JP)

(21) Appl. No.: 18/920,998

(22) Filed: Oct. 21, 2024

(30) Foreign Application Priority Data
Nov. 2, 2023 (JP) 2023-188616

(51) Int. Cl. H01M 50/184; H01M 50/105; H01M 50/186; H01M 50/211

(52) U.S. Cl. CPC H01M 50/184; H01M 50/105; H01M 50/186; H01M 50/211

(57) ABSTRACT

The present disclosure provides a battery which has high volumetric efficiency, and in which spring-back of a bent portion of a laminated film is inhibited. The battery of the present disclosure includes an electrode laminate and a laminated film sealing it. The laminated film in the battery of the present disclosure has an extending part which extends on a periphery of the electrode laminate, and is bent toward the electrode laminate. A total thickness of the first region of the electrode laminate and the laminated film sealing the first region is less than a total thickness of the second region of the electrode laminate and the laminated film sealing the second region. Further, in a portion of the laminated film sealing the first region, a belt-like member is arranged such that it is wound around the laminated film to immobilize the extending part.

### FIELD

The present disclosure relates to a battery.

### BACKGROUND

In batteries such as lithium ion secondary batteries, an electrode laminate which includes a positive electrode current collector layer, a positive electrode active material layer, an electrolyte layer, a negative electrode active material layer, and a negative electrode current collector layer is used in some cases. There are known various technologies for sealing such an electrode laminate.

For example, PTL 1 discloses a laminated battery (pouch battery) including: a laminated member obtained by superimposing a first film and a second film; and a battery cell housed between the first and the second films of the laminated member. In this laminated battery, a peripheral portion of the laminated member includes: an outer edge part where the first and the second films are bonded to each other; and an inner edge part where the first and the second films are not bonded to each other, and the outer edge part and the inner edge part are each bent at least once along the side surface of the battery cell.

PTL 2 discloses a secondary battery including: an electrode assembly (electrode laminate); and a heat-shrinkable protective layer that is arranged on the outer surface of the electrode assembly and shrinks with heat.

### CITATION LIST

### Patent Literature

[PTL 1] Japanese Unexamined Patent Publication (Kokai) No. 2016-139494

[PTL 2] U.S. Patent Application Publication No. 2018/0287184

### SUMMARY

### Technical Problem

Particularly, with regard to the technology of PTL 1, there is room for improvement in terms of inhibiting spring-back of a bent portion of the laminated film while improving the volumetric efficiency of the battery.

An object of the present disclosure is to provide a battery which has high volumetric efficiency, and in which spring-back of a bent portion of a laminated film is inhibited.

### Solution to Problem

The present inventors discovered that the above-described problem can be solved by the following means.

### <Aspect 1>

A battery, including an electrode laminate and a laminated film sealing the electrode laminate, wherein
the laminated film includes an extending part which extends on a periphery of the electrode laminate,
the extending part is bent toward the electrode laminate,
the electrode laminate includes a first region that is formed on at least one end, and a second region that is a region other than the first region,
a total thickness of the first region of the electrode laminate and the laminated film sealing the first region is less than a total thickness of the second region of the electrode laminate and the laminated film sealing the second region, and
in a portion of the laminated film sealing the first region, a belt-like member is arranged such that it is wound around the laminated film to immobilize the extending part.

### <Aspect 2>

The battery according to Aspect 1, wherein
the laminated film includes a fused layer, and
the extending part is formed by a fused end where fused layers of the respective ends of the laminated film are fused with each other.

### <Aspect 3>

The battery according to Aspect 1 or 2, wherein a total thickness of the first region of the electrode laminate, the laminated film sealing the first region, and the belt-like member is equal to or less than a total thickness of the second region of the electrode laminate and the laminated film sealing the second region.

### <Aspect 4>

The battery according to any one of Aspects 1 to 3, wherein the belt-like member is an adhesive tape.

### <Aspect 5>

The battery according to any one of Aspects 1 to 4, wherein
the electrode laminate is composed of plural preliminary laminates each including a negative electrode current collector layer, a negative electrode active material layer, an electrolyte layer, a positive electrode active material layer, and a positive electrode current collector layer in the order mentioned, and
the first region is a region that is formed due to that the positive electrode active material layer is smaller than the negative electrode active material layer in the planar direction.

### <Aspect 6>

The battery according to any one of Aspects 1 to 5, wherein
the battery further includes a current collector terminal that is electrically connected to a current collector foil of the electrode laminate, and
the laminated film seals the electrode laminate along with the current collector terminal.

### <Aspect 7>

A battery module, including plural batteries according to any one of Aspects 1 to 6 that are disposed in layers.

### Advantageous Effects of Invention

According to the present disclosure, a battery which has high volumetric efficiency, and in which spring-back of a bent portion of a laminated film is inhibited, can be provided.

### BRIEF DESCRIPTION OF DRAWINGS

FIG. 1A provides schematic perspective view illustrating one example of the battery of the present disclosure.

FIG. 1B provides schematic perspective view illustrating one example of the battery of the present disclosure.

FIG. 2A is a cross-sectional view taken along a line A-A of the battery of the present disclosure.

FIG. 2B is a cross-sectional view taken along a line B-B of the battery of the present disclosure.

FIG. 3 is a schematic side view illustrating one example of the battery of the present disclosure, with the first region of the electrode laminate being magnified.

FIG. 4 is a schematic side view illustrating one example of the electrode laminate in the battery of the present disclosure, with the first region being magnified.

FIG. 5 is a schematic perspective view illustrating one example of the battery module of the present disclosure.

### DESCRIPTION OF EMBODIMENTS

Embodiments of the present disclosure will now be described in detail. The present disclosure is, however, not limited to the below-described embodiments, and can be carried out with various modifications within the scope of the gist of the disclosure.

### Battery

The battery of the present disclosure includes an electrode laminate and a laminated film sealing the electrode laminate. The laminated film in the battery of the present disclosure has an extending part which extends on a periphery of the electrode laminate, and the extending part is bent toward the electrode laminate. The electrode laminate in the battery of the present disclosure has a first region that is formed on at least one end, and a second region that is a region other than the first region. In the battery of the present disclosure, a total thickness of the first region of the electrode laminate and the laminated film sealing the first region is less than a total thickness of the second region of the electrode laminate and the laminated film sealing the second region. Further, in the battery of the present disclosure, in a portion of the laminated film sealing the first region, a belt-like member is arranged such that it is wound around the laminated film to immobilize the extending part.

When sealing an electrode laminate with a laminated film, the volumetric efficiency of a battery can be improved by bending an extending part of the laminated film, which extends on a periphery of the electrode laminate, toward the electrode laminate. However, there is a problem that the bent extending part may spring-back and thereby restore its original state, as a result of which the volumetric efficiency of the battery is deteriorated.

In this regard, the present inventors conceived to, after sealing the electrode laminate with the laminated film, bend the extending part of the laminated film toward the electrode laminate and then arrange a belt-like member in a first region, which is formed on at least one end of the electrode laminate and has a smaller thickness than a second region, such that the belt-like member is wound around the laminated film to immobilize the extending part, thereby arriving at the present disclosure. It was discovered that, by this, the spring-back of the extending part can be inhibited, and the volumetric efficiency of the battery can be improved as a result.

Bending of a film with application of a force to its surface imposes a bending stress composed of tensile stress and compressive stress on the film. The term “spring-back” used herein refers to a phenomenon that, when the force applied to the film surface is released, the film tries to return back to a state prior to being bent in response to the bending stress.

The battery of the present disclosure will now be described by referring to the drawings. It is noted here that the dimensional relationships (e.g., length, width, and thickness) in the drawings of the present disclosure do not reflect the actual dimensional relationships.

A battery 100 of the present disclosure includes an electrode laminate 10 and a laminated film 20 sealing the electrode laminate 10.

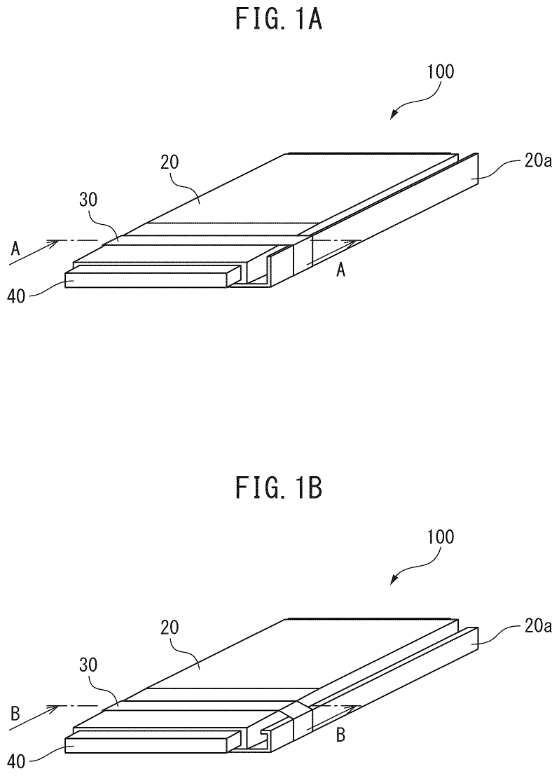

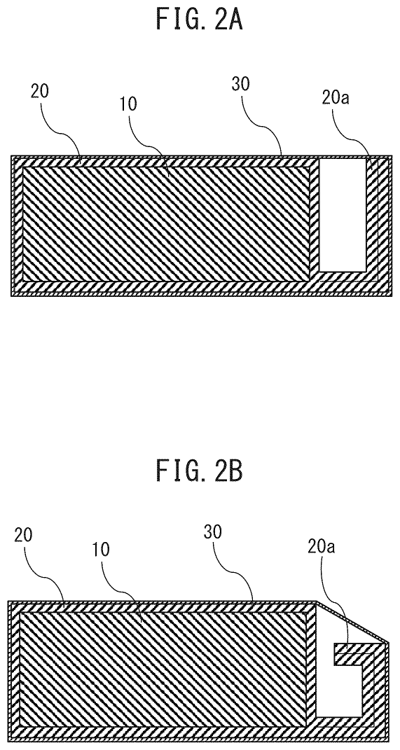

FIG. 1A provides schematic perspective view illustrating one example of the battery 100 of the present disclosure. FIG. 1B provides schematic perspective view illustrating one example of the battery 100 of the present disclosure. FIG. 2A is a cross-sectional view taken along a line A-A of the battery 100 of the present disclosure, and FIG. 2B is a cross-sectional view taken along a line B-B of the battery 100 of the present disclosure. As illustrated in FIGS. 1 and 2, the laminated film 20 in the battery of the present disclosure has an extending part 20a, which extends on a periphery of the electrode laminate 10 and is bent toward the electrode laminate 10.

The extending part 20a may be formed by fusion or adhesion of overlapping portions of the laminated film 20. For example, the laminated film 20 may have a fused layer, and the extending part 20a may be formed by a fused end where fused layers of the respective ends of the laminated film 20 are fused with each other. Alternatively, the extending part 20a may be formed by adhesion using an adhesive or the like. It is noted here that the extending part 20a may also include a portion that is neither fused nor adhered.

A position of the extending part 20a is not particularly limited, and the extending part 20a may be positioned in, for example, the lamination direction of the electrode laminate 10, and the direction perpendicular to the lamination direction of the electrode laminate 10 (see FIG. 2B). When the extending part 20a is positioned in the direction perpendicular to the lamination direction of the electrode laminate 10, an increase in the thickness of the battery 100 can be inhibited; therefore, at the time of stacking and restraining the battery 100, the below-described belt-like member 30 can be prevented from hindering the pressure uniformity.

The number of times of bending the extending part 20a is not particularly limited, and the extending part 20a may be bent once or multiple times. When the extending part 20a is bent multiple times, the extending part 20a may be bent twice or more, three times or more, four times or more, five times or more, and may be six times or less, five times or less, four times or less, three times or less, or twice or less. When the extending part 20a is bent only once, the laminated film easily springs back; therefore, the effect of the present disclosure of inhibiting spring-back is likely to be exerted. Meanwhile, when the extending part 20a is bent multiple times, the effect of the present disclosure of improving the volumetric efficiency of a battery is likely to be exerted.

A shape of a bent portion of the extending part 20a is not particularly limited, and can be designed as appropriate taking into consideration the volumetric efficiency of the battery 100, the pressure uniformity at the time of stacking and restraining the battery 100, and the like. In other words, the shape of a bent portion of the extending part 20a can be designed as appropriate in consideration of, for example, controlling the distance between the outer surface of the electrode laminate 10 and a portion of the extending part 20a that is farthest away from the outer surface of the electrode laminate 10 to be small, and preventing the extending part 20a from having a greater thickness than the electrode laminate 10 when the extending part 20a is bent.

In the battery 100 of the present disclosure, the electrode laminate 10 includes: a first region 10a that is formed on at least one end; and a second region 10b that is a region other than the first region 10a.

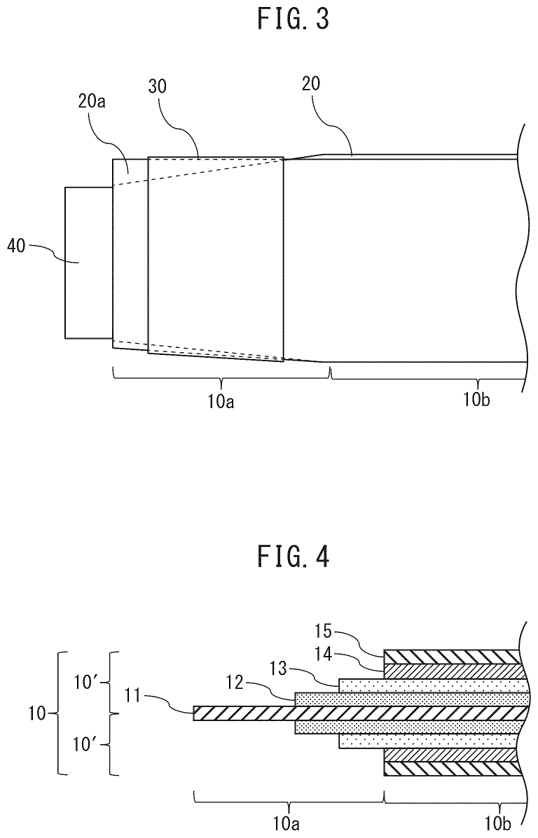

FIG. 3 is a schematic side view illustrating one example of the battery of the present disclosure, with the first region 10a of the electrode laminate 10 being magnified. As illustrated in FIG. 3, the first region 10a may have a tapered shape with a decreasing thickness toward a terminal of the electrode laminate 10.

It is noted here that, although FIG. 1 illustrates an aspect in which the first region 10a is formed on one end of the electrode laminate 10, the first region 10a may be formed on both ends of the electrode laminate 10.

FIG. 4 is a schematic side view illustrating one example of the electrode laminate 10, with the first region 10a being magnified. As illustrated in FIG. 4, the electrode laminate 10 may be composed of plural preliminary laminates 10′ each including a negative electrode current collector layer 11, a negative electrode active material layer 12, an electrolyte layer 13, a positive electrode active material layer 14, and a positive electrode current collector layer 15, in the order mentioned. For example, in a lithium ion secondary battery, in order to inhibit the precipitation of lithium on a negative electrode active material layer, the negative electrode active material layer may be configured to be larger than a positive electrode active material layer. In this case, as illustrated in FIG. 4, an end portion of the electrode laminate 10 may have a shape that appears to be sloped. The first region 10a may be a region that is formed due to that, in this manner, the negative electrode active material layer 12 is larger than the positive electrode active material layer 14 in the planar direction, i.e. the positive electrode active material layer 14 is smaller than the negative electrode active material layer 12 in the planar direction.

It is noted here that, although the electrode laminate 10 in FIG. 4 is illustrated to have preliminary laminates 10′ that are disposed in two layers; however, the number of the layers of the preliminary laminates is not limited thereto.

As illustrated in FIG. 3, in the battery 100 of the present disclosure, a total thickness of the first region 10a of the electrode laminate 10 and the laminated film 20 sealing the first region 10a is less than a total thickness of the second region 10b of the electrode laminate 10 and the laminated film 20 sealing the second region 10b.

Further, as illustrated in FIGS. 1 to 3, in the battery 100 of the present disclosure, a belt-like member 30 is arranged in a portion of the laminated film 20 sealing the first region 10a such that the belt-like member 30 is wound around the laminated film 20 to immobilize the extending part 20a.

As illustrated in FIG. 3, a total thickness of the first region 10a of the electrode laminate 10, the laminated film 20 sealing the first region 10a, and the belt-like member 30 may be equal to or less than a total thickness of the second region 10b of the electrode laminate 10 and the laminated film 20 sealing the second region 10b. By adopting this configuration, an increase in the thickness of the battery 100 can be inhibited; therefore, at the time of stacking and restraining plural batteries 100, the belt-like member 30 can be prevented from hindering the pressure uniformity.

The restraining pressure applied at the time of stacking and restraining plural batteries 100 may be 0.1 MPa or more, 0.5 MPa or more, 1.0 MPa or more, 3.0 MPa or more, or 5.0 MPa or more, and may be 30.0 MPa or less, 10.0 MPa or less, 5.0 MPa or less, 3.0 MPa or less, or 1.0 MPa or less.

The belt-like member 30 is not particularly limited as long as it can inhibit the spring-back of the bent extending part 20a. Examples of the belt-like member 30 include an adhesive tape and an elastic member such as a rubber band.

The adhesive tape used as the belt-like member 30 may be adhesive at least on the edge of one surface, or may be adhesive on the entirety of one surface. When the adhesive tape is adhesive only on the edge of one surface, a load applied to the electrode laminate 10 can be reduced. When the adhesive tape is adhesive on the entirety of one surface, the effect of inhibiting the spring-back of the extending part 20a of the laminated film 20 is enhanced. The strength of a material constituting the adhesive tape can be designed as appropriate taking into consideration, for example, the bending stress applied to the bent laminated film 20.

When the belt-like member 30 is an elastic member such as a rubber band, the inner circumferential length of a closed region formed by the elastic member, the elastic modulus of the elastic member, and the like can be designed as appropriate taking into consideration, for example, not to apply an excessive load to the electrode laminate 10.

As illustrated in FIG. 1, the battery 100 of the present disclosure may further include a current collector terminal 40 which is electrically connected to a current collector foil of the electrode laminate 10. The laminated film 20 may seal the electrode laminate 10 along with the current collector terminal 40. Specifically, the laminated film 20 may be wound around the electrode laminate 10 and the current collector terminal 40 to seal the electrode laminate 10 along with the current collector terminal 40. Further, the laminated film 20 may be composed of first and second films and, in this case, the first and the second films sandwich the electrode laminate 10 and the current collector terminal 40 from above and below in the lamination direction of the electrode laminate 10 to seal the electrode laminate 10 along with the current collector terminal 40.

### Electrode Laminate

The electrode laminate 10 functions as a power generation element of the battery 100. A shape of the electrode laminate 10 is not particularly limited and, for example, the electrode laminate 10 may have a top surface section, a bottom surface section facing the top surface section, and four side surface sections connecting the top surface section and the bottom surface section. A shape of the top surface section is not particularly limited, and examples thereof include quadrangular shapes, such as a square, a rectangle, a rhomboid, a trapezoid, and a parallelogram. The shape of the top surface section may also be a polygonal shape other than a quadrangular shape, or may be a shape having a curve, such as a circular shape. Further, the bottom surface section has the same shape as the top surface section. A shape of the side surface sections is not particularly limited, and examples thereof include quadrangular shapes, such as a square, a rectangle, a rhomboid, a trapezoid, and a parallelogram.

### Laminated Film

The laminated film 20 may include a fused layer, a metal layer, and a resin layer in this order along the thickness direction. Examples of a material of the fused layer include olefin-based resins, such as polypropylene (PP) and polyethylene (PE). Examples of a material of the metal layer include aluminum, aluminum alloys, and stainless steel. Examples of a material of the resin layer include polyethylene terephthalate (PET) and nylon. The fused layer has a thickness of, for example, 40 μm or more and 100 μm or less. The metal layer has a thickness of, for example, 30 μm or more and 60 μm or less. The resin layer has a thickness of, for example, 20 μm or more and 60 μm or less. The laminated film has a thickness of, for example, 80 μm or more and 250 μm or less.

### Current Collector Terminal

The current collector terminal 40 may be electrically connected to a current collector foil. A material of the current collector terminal 40 is not particularly limited as long as it has a current collecting function, and may be, for example, the same metal material as that of the positive electrode current collector and the negative electrode current collector. A size, a shape, and the like of the current collector terminal 40 are also not particularly limited.

The battery of the present disclosure may be a liquid-based battery or solid-state battery. Regarding the present disclosure, the term “solid-state battery” means a battery in which at least a solid electrolyte is used as an electrolyte; therefore, the solid-state battery may contain, as an electrolyte, a combination of a solid electrolyte and a liquid electrolyte. Further, the solid-state battery of the present disclosure may be an all-solid-state battery, i.e. a battery in which only a solid electrolyte is used as an electrolyte.

The battery of the present disclosure may be a lithium ion secondary battery as well. Examples of the use of this battery include power sources of vehicles, such as hybrid electric vehicles (HEVs), plug-in hybrid electric vehicles (PHEVs), battery electric vehicles (BEV), gasoline vehicles, and diesel vehicles. The battery is particularly preferably used as a power source for driving a hybrid electric vehicle (HEV), a plug-in hybrid vehicle (PHEV), or a battery electric vehicle (BEV). Further, the battery of the present disclosure may be used as a power source of a mobile body (e.g., a train, a ship, or an airplane) other than a vehicle, or as a power source of an electric appliance such as an information processing device.

### Battery Module

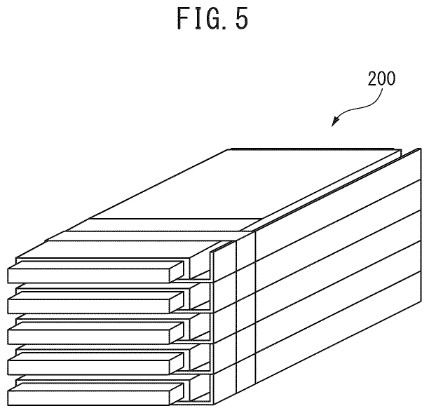

FIG. 5 is a schematic perspective view illustrating one example of a battery module 200 of the present disclosure. The battery module 200 of the present disclosure includes plural batteries 100 of the present disclosure that are disposed in layers. With regard to the batteries 100 of the present disclosure, reference can be made to the above description relating to the battery of the present disclosure. Particularly, in each battery 100 of the present disclosure, when a total thickness of the first region 10a of the electrode laminate 10, the laminated film 20 sealing the first region 10a, and the belt-like member 30 is equal to or less than a total thickness of the second region 10b of the electrode laminate 10 and the laminated film 20 sealing the second region 10b, an increase in the thickness of the battery 100 can be inhibited; therefore, at the time of stacking and restraining plural batteries 100, the belt-like member 30 can be prevented from hindering the pressure uniformity.

### REFERENCE SIGNS LIST

100 battery
200 battery module
10 electrode laminate
10a first region
10b second region
20 laminated film
20a extending part
30 belt-like member
40 current collector terminal

1. A battery, including an electrode laminate and a laminated film sealing the electrode laminate, wherein
the laminated film includes an extending part which extends on a periphery of the electrode laminate,
the extending part is bent toward the electrode laminate,
the electrode laminate includes a first region that is formed on at least one end, and a second region that is a region other than the first region,
a total thickness of the first region of the electrode laminate and the laminated film sealing the first region is less than a total thickness of the second region of the electrode laminate and the laminated film sealing the second region, and
in a portion of the laminated film sealing the first region, a belt-like member is arranged such that it is wound around the laminated film to immobilize the extending part.

2. The battery according to claim 1, wherein
the laminated film includes a fused layer, and
the extending part is formed by a fused end where fused layers of the respective ends of the laminated film are fused with each other.

3. The battery according to claim 1, wherein a total thickness of the first region of the electrode laminate, the laminated film sealing the first region, and the belt-like member is equal to or less than a total thickness of the second region of the electrode laminate and the laminated film sealing the second region.

4. The battery according to claim 1, wherein the belt-like member is an adhesive tape.

5. The battery according to claim 1, wherein
the electrode laminate is composed of plural preliminary laminates each including a negative electrode current collector layer, a negative electrode active material layer, an electrolyte layer, a positive electrode active material layer, and a positive electrode current collector layer in the order mentioned, and
the first region is a region that is formed due to that the positive electrode active material layer is smaller than the negative electrode active material layer in the planar direction.

6. The battery according to claim 1, wherein
the battery further includes a current collector terminal that is electrically connected to a current collector foil of the electrode laminate, and
the laminated film seals the electrode laminate along with the current collector terminal.

7. A battery module, including plural batteries according to claim 1 that are disposed in layers.
